(19) United States
(12) Patent Application Publication
(10) Pub. No.: US 2022/0184911 A1
(43) Pub. Date: Jun. 16, 2022

(54) BEAD CORE COVERING METHOD AND BEAD CORE COVERING APPARATUS

(71) Applicant: Toyo Tire Corporation, Itami-shi, Hyogo (JP)

(72) Inventors: Yoshiki Hashimoto, Itami-shi (JP); Ryoshi Miyamoto, Itami-shi (JP)

(73) Assignee: Toyo Tire Corporation, Itami-Shi, Hyogo (JP)

(21) Appl. No.: 17/603,201

(22) PCT Filed: May 14, 2020
(86) PCT No.: PCT/JP2020/019274

§ 371 Date: Oct. 12, 2021

(30) Foreign Application Priority Data
May 17, 2019 (JP) 2019-093502

(51) Int. Cl. B29D 30/50

(52) U.S. Cl. CPC B29D 30/50

(57) ABSTRACT

A bead core covering method for covering an annular bead core with a long, belt-like rubber sheet, includes: affixing a part in a width direction of the rubber sheet onto an outer surface of the bead core that is rotating; and winding a remaining part in the width direction of the rubber sheet having been affixed to the outer surface of the bead core along a cross-sectional shape of the bead core sequentially from the part in the width direction toward an end in the width direction, wherein, the remaining part in the width direction of the rubber sheet is bonded under pressure to the outer surface of the bead core by outer peripheral surfaces of first and second bending rollers that are rotating, and peripheral speeds of the first second bending rollers are higher than the peripheral speed of the bead core.

### TECHNICAL FIELD

The present invention relates to a bead core covering method and a bead core covering apparatus for covering an annular bead core with a long, belt-like rubber sheet having a predetermined width.

### BACKGROUND ART

In general, an annular bead core formed by covering a bundle of steel wires or the like with rubber is disposed in a bead portion of a pneumatic tire. The surface of the bead core may be covered with a thin rubber sheet to integrate steel wires or the like. This rubber sheet may be referred to as a cover rubber or a bead cover rubber.

Patent Document 1 below discloses a bead core covering method including a step for affixing, from a front end, a part in the width direction of a rubber sheet extruded from an extruder onto an outer surface of a bead core that is rotating; and a step for winding a remaining part in the width direction of the rubber sheet having been affixed to the outer surface of the bead core along a cross-sectional shape of the bead core. The rubber sheet is wound along the cross-sectional shape of the bead core using a winding roller.

Patent Document 2 below discloses a bead core covering apparatus for covering the surface of a bead core with a sheet member fed from a bobbin, the apparatus including a winding roller for winding an end of the sheet member on the surface of the bead core. The rotational speed of the winding roller is appropriately set with respect to the rotational speed of the bead core, and is changed according to the diameter of the bead core.

In Patent Documents 1 and 2, the rubber sheet (sheet member) is wound along the cross-sectional shape of the bead core using the winding roller, but the rubber sheet may be wrinkled or bent to cause winding failure.

### PRIOR ART DOCUMENTS

### Patent Documents

Patent Document 1: JP-A-2017-193088
Patent Document 2: JP-A-2012-240334

### SUMMARY OF THE INVENTION

### Problems to be Solved by the Invention

In view of this, an object of the present invention is to provide a bead core covering method and a bead core covering apparatus capable of winding a belt-like rubber sheet around an outer surface of a bead core so as to cover the outer surface of the bead core with the belt-like rubber sheet with winding failure being reduced.

### Means for Solving the Problems

The above object can be achieved by the present invention as described below.

That is, a bead core covering method according to the present invention is for covering an annular bead core with a long, belt-like rubber sheet having a predetermined width, the method includes:

a step for affixing, from a front end of the rubber sheet, a part in a width direction of the rubber sheet onto an outer surface of the bead core that is rotating; and

a step for winding a remaining part in the width direction of the rubber sheet having been affixed to the outer surface of the bead core along a cross-sectional shape of the bead core sequentially from the part in the width direction toward an end in the width direction,

wherein, in the step for winding the rubber sheet along the cross-sectional shape of the bead core, the remaining part in the width direction of the rubber sheet is bonded under pressure to the outer surface of the bead core by an outer peripheral surface of a drive roller that is rotating, and

a peripheral speed of the outer peripheral surface of the drive roller is higher than a peripheral speed of the outer surface of the bead core.

In the bead core covering method according to the present invention, the peripheral speed of the drive roller may be 1.3 times or less the peripheral speed of the bead core.

In addition, in the bead core covering method according to the present invention, the drive roller may bend and bond the rubber sheet under pressure at a corner of the bead core having a polygonal cross section, and may be disposed at a position where a bending angle of the rubber sheet is 45° or more.

In the bead core covering method according to the present invention, in the step for winding the rubber sheet along the cross-sectional shape of the bead core, the rubber sheet is bonded under pressure to the outer surface of the bead core by the outer peripheral surface of the rotating drive roller, and the peripheral speed of the outer peripheral surface of the drive roller is set higher than the peripheral speed of the outer surface of the bead core. According to this configuration, the drive roller has a function of constantly feeding the rubber sheet in the direction of winding the rubber sheet, and thus, winding failure is reduced. In addition, tension is applied to the rubber sheet, whereby the wound state is also improved.

The bead core covering apparatus according to the present invention is for covering an annular bead core with a long, belt-like rubber sheet having a predetermined width, the apparatus includes:

a covering device that supports the bead core and rotates the bead core that is supported;

a drive roller for winding and bonding the rubber sheet under pressure on an outer surface of the bead core, the drive roller being provided to the covering device; and

a control unit that controls the covering device and the drive roller,

wherein the control unit is configured to affix, from a front end of the rubber sheet, a part in a width direction of the rubber sheet onto the outer surface of the bead core that is rotating, and to bond under pressure a remaining part in the width direction of the rubber sheet having been affixed to the outer surface of the bead core along a cross-sectional shape of the bead core sequentially from the part in the width direction toward an end in the width direction by an outer peripheral surface of the drive roller that is rotating, and

a peripheral speed of the outer peripheral surface of the drive roller is higher than a peripheral speed of the outer surface of the bead core.

In the bead core covering apparatus according to the present invention, the peripheral speed of the drive roller may be 1.3 times or less the peripheral speed of the bead core.

In the bead core covering apparatus according to the present invention, the drive roller may bend and bond the rubber sheet under pressure at a corner of the bead core having a polygonal cross section, and may be disposed at a position where a bending angle of the rubber sheet is 45° or more.

The operation and effect of the bead core covering apparatus having such a configuration are as described in the bead core covering method, and the bead core covering apparatus can wind the belt-like rubber sheet around the outer surface of the bead core so as to cover the outer surface of the bead core with the rubber sheet with winding failure being reduced.

### BRIEF DESCRIPTION OF THE DRAWINGS

FIG. 1 is a schematic diagram illustrating an example of a configuration of a bead core covering apparatus.

FIG. 2 is a schematic diagram illustrating an example of configurations of an extruder and a rotary drum.

FIG. 3 is a cross-sectional view of a bead core.

FIG. 4A is a cross-sectional view taken along line A-A of FIG. 1.

FIG. 4B is a cross-sectional view taken along line B-B of FIG. 1.

FIG. 4C is a cross-sectional view taken along line C-C of FIG. 1.

FIG. 4D is a cross-sectional view taken along line D-D of FIG. 1.

FIG. 4E is a cross-sectional view taken along line E-E of FIG. 1.

FIG. 4F is a cross-sectional view taken along line F-F of FIG. 1.

FIG. 4G is a cross-sectional view taken along line G-G of FIG. 1.

FIG. 4H is a cross-sectional view taken along line H-H of FIG. 1.

FIG. 4I is a cross-sectional view taken along line I-I of FIG. 1.

### MODE FOR CARRYING OUT THE INVENTION

Embodiments of the present invention will be described below with reference to the drawings. A bead core covering method and a bead core covering apparatus according to the present invention are for covering an annular bead core with a long, belt-like rubber sheet having a predetermined width. In the following description, the bead core in the present embodiment has a hexagonal cross section. However, the cross section of the bead core that can be covered by the bead core covering method and the bead core covering apparatus according to the present invention is not limited to have a hexagonal shape, and may have a rectangular shape, a circular shape, or the like.

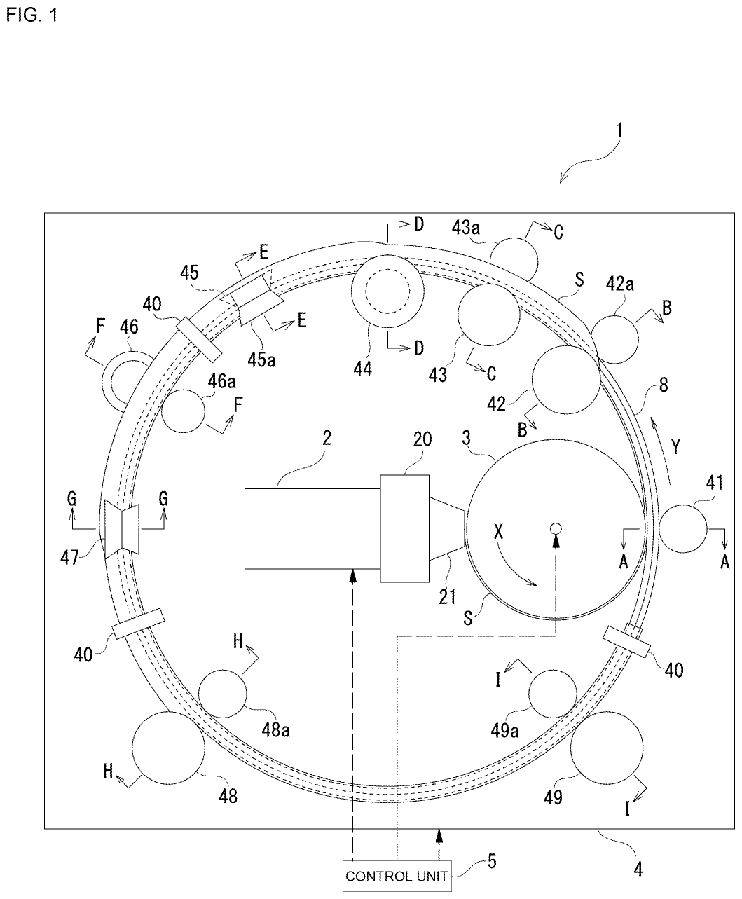

FIG. 1 is a schematic diagram illustrating an example of a configuration of the bead core covering apparatus 1. The bead core covering apparatus 1 includes the extruder 2, the rotary drum 3, a covering device 4, and a control unit 5 that controls the extruder 2, the rotary drum 3, and the covering device 4.

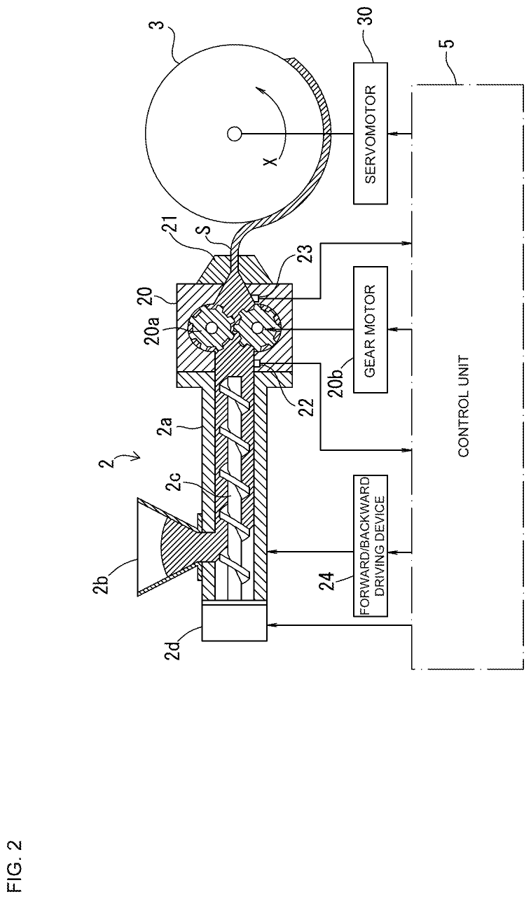

FIG. 2 is a schematic diagram illustrating an example of configurations of the extruder 2 and the rotary drum 3. The extruder 2 includes a cylindrical barrel 2a, a hopper 2b connected to a supply port of the barrel 2a, a screw 2c that kneads and feeds rubber to a tip side, and a screw motor 2d that rotationally drives the screw 2c. The rotation speed of the screw motor 2d is controlled by the control unit 5 as described later.

A gear pump 20 is connected to the tip side of the extruder 2 in the extrusion direction, and a tip of the gear pump 20 is connected to 1. A rubber material kneaded by the extruder 2 is supplied to the gear pump 20, and the gear pump 20 supplies a given amount of rubber to the die 21. The rubber sheet S is extruded in a predetermined extrusion amount from the die 21.

The gear pump 20 has a pair of gears 20a, and has a function of feeding rubber to an outlet side toward the die 21. Each of the pair of gears 20a is rotated and driven by a gear motor 20b, and the rotation speed of the gears 20a is controlled by the control unit 5. The extrusion amount of the rubber sheet S extruded from the die 21 can be controlled by controlling the rotation speed of the gear motor 20b and the rotation speed of the screw motor 2d in conjunction with each other by the control unit 5. For convenience of illustration, the pair of gears 20a is arranged in the vertical direction in FIG. 2, but they may be actually arranged in the planar direction (direction in which rotation axes of the gears 20a are oriented in the vertical direction in FIG. 2).

A first pressure sensor 22 is provided on the inlet side of the gear pump 20, that is, on the side close to the extruder 2, and detects the pressure of rubber supplied from the extruder 2. A second pressure sensor 23 is provided on the outlet side of the gear pump 20, and detects the pressure of the rubber sheet S extruded from the die 21.

The pressure on the inlet side of the gear pump 20 is determined by the amount of rubber fed by the gears 20a of the gear pump 20 and the screw 2c of the extruder 2. By keeping the pressure on the inlet side constant, the gear pump 20 can supply a fixed amount of rubber to the die 21, and the extrusion amount from the die 21 is also stabilized. However, if the pressure on the inlet side is unstable, the extrusion amount from the die 21 varies, which makes it difficult to form the rubber sheet S having a desired dimension.

As a method for controlling the pressure on the inlet side of the gear pump 20, it is known to perform PID control on the rotation speed of the gears 20a of the gear pump 20 and the rotation speed of the screw 2c of the extruder 2. Such PID control is generally used to continuously extrude rubber in a given amount.

The control unit 5 controls the rotation speed of the screw motor 2d of the extruder 2 on the basis of the pressure on the inlet side of the gear pump 20 detected by the first pressure sensor 22. The control unit 5 controls the rotation speed of the gear motor 20b on the basis of a predetermined control program (based on a time factor).

The present embodiment shows an example of a so-called external gear pump in which the gear pump 20 is connected to the tip side of the extruder 2 in the extrusion direction. Alternatively, it is also possible to use a gear-pump-equipped extruder in which the gear pump is incorporated in the extruder. In the present invention, the gear-pump-equipped extruder is more preferable than the extruder to which an external gear pump is connected, because it can easily control the extrusion amount, and further, does not require a gear motor, which makes the tip of the extruder compact.

The extruder 2, the gear pump 20, and the die 21 can integrally be moved forward and backward in the extrusion direction by a forward/backward driving device 24, and can move toward and away from the rotary drum 3. Such forward and backward movement is also controlled by the control unit 5.

The rotary drum 3 is rotatable in an X direction by a servomotor 30. The rotational speed of the servomotor 30 is controlled by the control unit 5. The rubber sheet S extruded through the die 21 is supplied to the outer peripheral surface of the rotary drum 3, and can be wound along the circumferential direction by rotationally driving the rotary drum 3 in the X direction with the rubber sheet S affixed thereto. The outer peripheral surface of the rotary drum 3 is made of metal. The outer diameter of the rotary drum 3 in the present embodiment is, for example, 200 to 400 mm.

The rotary drum 3 preferably includes a cooling mechanism or a heating mechanism for cooling or heating the outer peripheral surface. As the cooling mechanism or the heating mechanism, a mechanism for circulating cooling water or hot water inside the rotary drum 3 is used, for example. In addition, a surface treatment or a material for facilitating removal of the rubber sheet S affixed to the outer peripheral surface of the rotary drum 3 is performed or used for the outer peripheral surface of the rotary drum 3.

The covering device 4 supports the bead core 8 such that the outer peripheral surface of the rotary drum 3 and the outer surface of the bead core 8 are close to each other at a position forward in the rotation direction X of the rotary drum 3 with respect to the extruder 2, and rotates the supported bead core 8. In the present embodiment, the position where the tip of the die 21 of the extruder 2 and the outer peripheral surface of the rotary drum 3 are closest to each other and the position where the inner peripheral surface of the bead core 8 and the outer peripheral surface of the rotary drum 3 are closest to each other are shifted by 180° in the rotation direction X of the rotary drum 3. In the present embodiment, the outer diameter of the rotary drum 3 is smaller than the inner diameter of the bead core 8, and the rotary drum 3 is disposed on the inner peripheral side of the bead core 8 supported by the covering device 4.

The covering device 4 is for winding the rubber sheet S affixed to the outer surface of the bead core 8 along the cross-sectional shape of the bead core 8. The covering device 4 can rotate the supported bead core 8 in a Y direction. The bead core 8 rotates as the rotary drum 3 rotates.

FIG. 3 is a cross-sectional view of the bead core 8. The bead core 8 of the present embodiment has a hexagonal cross section, and the inner peripheral surface of the bead core 8 is defined as a lower surface 8a, the outer peripheral surface is defined as an upper surface 8d, the side surfaces on the inner peripheral side are defined as lower side surfaces 8b and 8f, and the side surfaces on the outer peripheral side are defined as upper side surfaces 8c and 8e. The rubber sheet S is wound around the surface of the bead core 8. A bead filler 9 having a substantially triangular cross section is disposed on the outer peripheral side of the bead core 8. The inner diameter of the bead core 8 of the present embodiment is, for example, 400 to 650 mm.

The covering device 4 includes a pressing roller 41, a first forming roller 42, lower-side-surface press-bonding rollers 43, a second forming roller 44, a first upper-side-surface press-bonding roller 45, a first bending roller 46, a second upper-side-surface press-bonding roller 47, a second bending roller 48, and a finishing roller 49 in this order from the rear side to the front side in the rotation direction Y of the bead core 8. The covering device 4 is also provided with a plurality of guide rollers 40 that prevent meandering of the rotating bead core 8.

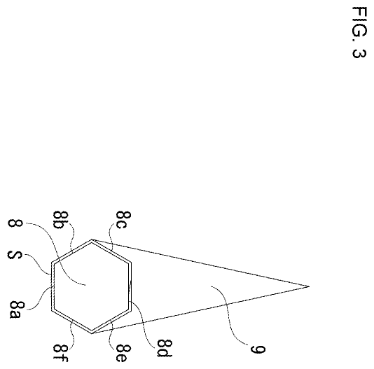

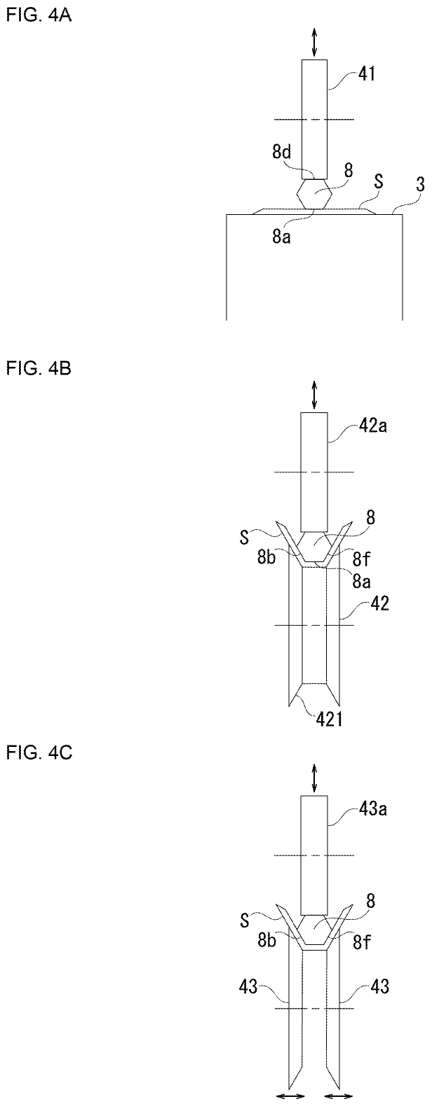

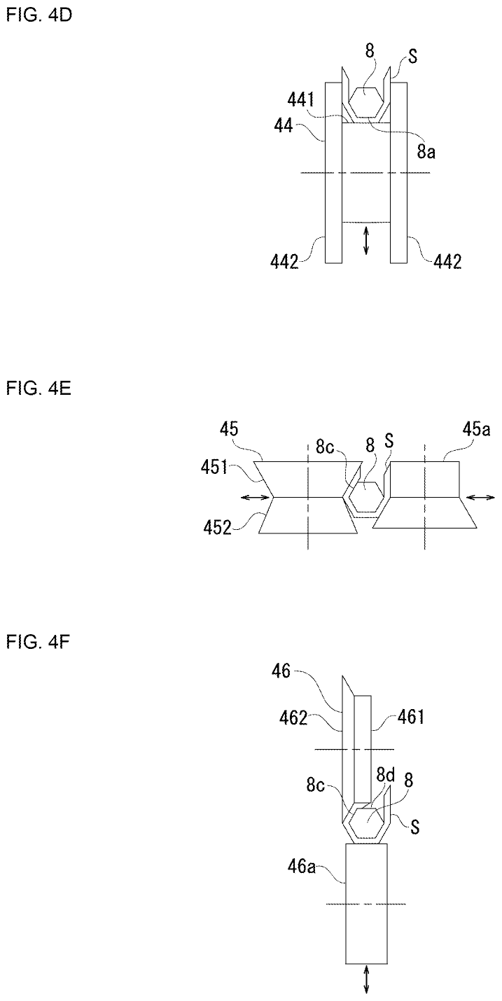

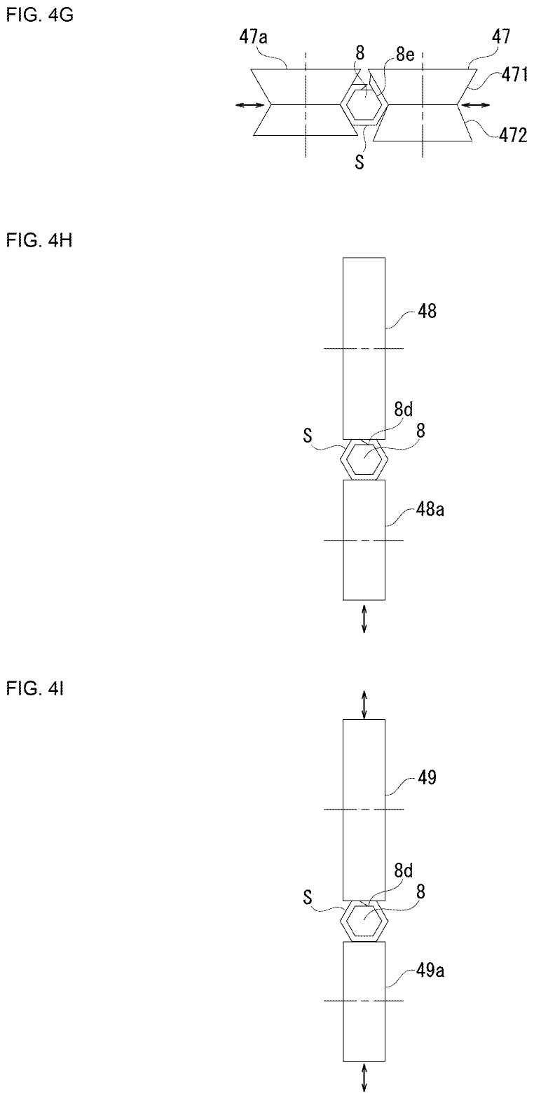

FIG. 4A is a cross-sectional view taken along line A-A of FIG. 1. The rubber sheet S is wound around the outer peripheral surface of the rotary drum 3. In the cross section of the rubber sheet S of the present embodiment, both ends in the width direction are thin, and when the rubber sheet S is wound around the surface of the bead core 8 and both ends in the width direction are joined, the thinned portions are overlapped with each other to prevent an increase in thickness of a joint portion.

The pressing roller 41 is disposed at a position facing the rotary drum 3 with a part of the bead core 8 interposed therebetween. The rotation axis of the pressing roller 41 is parallel to the rotation axes of the rotary drum 3 and the bead core 8, and the pressing roller 41 rotates while in contact with the upper surface 8d of the bead core 8 at the outer peripheral surface. The pressing roller 41 is movable inward and outward in the radial direction of the bead core 8. As a result, when a part of the rubber sheet S in the width direction on the outer peripheral surface of the rotary drum 3 is affixed to the lower surface 8a of the rotating bead core 8, the pressing roller 41 can press the upper surface 8d of the bead core 8. The pressing roller 41 is a driven roller that rotates with the rotation of the bead core 8.

FIG. 4B is a cross-sectional view taken along line B-B of FIG. 1. The first forming roller 42 is disposed on the inner peripheral side of the bead core 8. The rotation axis of the first forming roller 42 is parallel to the rotation axis of the bead core 8. As illustrated in FIG. 4B, the first forming roller 42 has a bobbin shape in which the central part is recessed with respect to the left and right parts. A recess 421 of the first forming roller 42 is disposed so as to be in contact with the lower surface 8a and the left and right lower side surfaces 8b and 8f of the bead core 8 with the rubber sheet S therebetween. An auxiliary roller 42a which is movable inward and outward in the radial direction of the bead core 8 is disposed at a position facing the first forming roller 42 with the bead core 8 interposed therebetween. The rotation axis of the auxiliary roller 42a is parallel to the rotation axes of the first forming roller 42 and the bead core 8. Thus, the rubber sheet S can be folded upward along the left and right lower side surfaces 8b and 8f of the bead core 8 by the recess 421 of the first forming roller 42. The first forming roller 42 and the auxiliary roller 42a are driven rollers that rotate with the rotation of the bead core 8.

FIG. 4C is a cross-sectional view taken along line C-C of FIG. 1. The lower-side-surface press-bonding rollers 43 are disposed on the inner peripheral side of the bead core 8. The rotation axes of the lower-side-surface press-bonding rollers 43 are parallel to the rotation axis of the bead core 8. The lower-side-surface press-bonding rollers 43 are provided so as to face the left and right parts of the bead core 8, respectively. The pair of lower-side-surface press-bonding rollers 43 is movable to the left and right in the width direction of the bead core 8. The lower-side-surface press-bonding rollers 43 have a shape of a truncated cone, and are disposed such that outer peripheral surfaces which are tapered surfaces are in contact with the lower side surfaces 8b and 8f of the bead core 8, respectively, with the rubber sheet S interposed therebetween. An auxiliary roller 43a which is movable inward and outward in the radial direction of the bead core 8 is disposed at a position facing the lower-side-surface press-bonding rollers 43 with the bead core 8 interposed therebetween. The rotation axis of the auxiliary roller 43a is parallel to the rotation axes of the lower-side-surface press-bonding rollers 43 and the bead core 8. With this configuration, the rubber sheet S can be bonded to the lower side surfaces 8b and 8f of the bead core 8 under pressure by the lower-side-surface press-bonding rollers 43. The lower-side-surface press-bonding rollers 43 are drive rollers driven by a motor (not illustrated), and the auxiliary roller 43a is a driven roller that rotates with the rotation of the bead core 8.

FIG. 4D is a cross-sectional view taken along line D-D of FIG. 1. The second forming roller 44 is disposed on the inner peripheral side of the bead core 8. The rotation axis of the second forming roller 44 is parallel to the rotation axis of the bead core 8. The second forming roller 44 includes a body part 441 that rotates along the lower surface 8a of the bead core 8 and disk-shaped flanges 442 provided at both ends of the body part 441. The interval between the left and right flanges 442 is substantially the same as the width obtained by adding the thickness of the rubber sheet S on both sides to the width of the bead core 8. The second forming roller 44 is movable inward and outward in the radial direction of the bead core 8. Thus, both ends of the rubber sheet S in the width direction can be raised upward by the flanges 442 of the second forming roller 44. The second forming roller 44 is a driven roller that rotates with the rotation of the bead core 8.

FIG. 4E is a cross-sectional view taken along line E-E of FIG. 1. The first upper-side-surface press-bonding roller 45 is disposed on the side of the bead core 8. The rotation axis of the first upper-side-surface press-bonding roller 45 is parallel to the radial direction of the bead core 8. The first upper-side-surface press-bonding roller 45 has a bobbin shape in which two truncated cone parts 451 and 452 are joined. The outer peripheral surface of the truncated cone part 451 is disposed so as to be in contact with the upper side surface 8c of the bead core 8 with the rubber sheet S therebetween. The first upper-side-surface press-bonding roller 45 is movable to the left and right in the width direction of the bead core 8. An auxiliary roller 45a which is movable to the left and right in the width direction of the bead core 8 is disposed at a position facing the first upper-side-surface press-bonding roller 45 with the bead core 8 interposed therebetween. The rotation axis of the auxiliary roller 45a is parallel to the rotation axis of the first upper-side-surface press-bonding roller 45. Thus, the rubber sheet S can be bent and bonded to the upper side surface 8c of the bead core 8 under pressure by the truncated cone part 451 of the first upper-side-surface press-bonding roller 45. The first upper-side-surface press-bonding roller 45 is a drive roller driven by a motor (not illustrated), and the auxiliary roller 45a is a driven roller that rotates with the rotation of the bead core 8.

FIG. 4F is a cross-sectional view taken along line F-F of FIG. 1. The first bending roller 46 is disposed on the outer peripheral side of the bead core 8. The rotation axis of the first bending roller 46 is parallel to the rotation axis of the bead core 8. The first bending roller 46 includes a cylindrical part 461 that rotates along the upper surface 8d of the bead core 8 and a truncated cone part 462 provided at one end of the cylindrical part 461. The outer peripheral surface of the truncated cone part 462 is disposed so as to be in contact with the upper side surface 8c of the bead core 8 with the rubber sheet S therebetween. An auxiliary roller 46a which is movable inward and outward in the radial direction of the bead core 8 is disposed at a position facing the cylindrical part 461 of the first bending roller 46 with the bead core 8 interposed therebetween. The rotation axis of the auxiliary roller 46a is parallel to the rotation axes of the first bending roller 46 and the bead core 8. Thus, one end of the rubber sheet S can be bent and bonded under pressure along the upper surface 8d of the bead core 8 by the cylindrical part 461 of the first bending roller 46. The first bending roller 46 is a drive roller driven by a motor (not illustrated), and the auxiliary roller 46a is a driven roller that rotates as the bead core 8 rotates.

FIG. 4G is a cross-sectional view taken along line G-G of FIG. 1. The second upper-side-surface press-bonding roller 47 is disposed on the side of the bead core 8. The rotation axis of the second upper-side-surface press-bonding roller 47 is parallel to the radial direction of the bead core 8. The second upper-side-surface press-bonding roller 47 has a bobbin shape in which two truncated cone parts 471 and 472 are joined. The outer peripheral surface of the truncated cone part 471 is disposed so as to be in contact with the upper side surface 8e of the bead core 8 with the rubber sheet S therebetween. The second upper-side-surface press-bonding roller 47 is movable to the left and right in the width direction of the bead core 8. An auxiliary roller 47a which is movable to the left and right in the width direction of the bead core 8 is disposed at a position facing the second upper-side-surface press-bonding roller 47 with the bead core 8 interposed therebetween. The rotation axis of the auxiliary roller 47a is parallel to the rotation axis of the second upper-side-surface press-bonding roller 47. Thus, the rubber sheet S can be bent and bonded under pressure to the upper side surface 8e of the bead core 8 by the truncated cone part 471 of the second upper-side-surface press-bonding roller 47. The second upper-side-surface press-bonding roller 47 is a drive roller driven by a motor (not illustrated), and the auxiliary roller 47a is a driven roller that rotates as the bead core 8 rotates.

FIG. 4H is a cross-sectional view taken along line H-H of FIG. 1. The second bending roller 48 is disposed on the outer peripheral side of the bead core 8. The rotation axis of the second bending roller 48 is parallel to the rotation axis of the bead core 8. The second bending roller 48 rotates along the upper surface 8d of the bead core 8. An auxiliary roller 48a which is movable inward and outward in the radial direction of the bead core 8 is disposed at a position facing the second bending roller 48 with the bead core 8 interposed therebetween. The rotation axis of the auxiliary roller 48a is parallel to the rotation axes of the second bending roller 48 and the bead core 8. Thus, the other end of the rubber sheet S can be bent and bonded under pressure along the upper surface 8d of the bead core 8 by the second bending roller 48. The second bending roller 48 is a drive roller driven by a motor (not illustrated), and the auxiliary roller 48a is a driven roller that rotates as the bead core 8 rotates.

FIG. 4I is a cross-sectional view taken along line I-I of FIG. 1. The finishing roller 49 is disposed on the outer peripheral side of the bead core 8. The rotation axis of the finishing roller 49 is parallel to the rotation axis of the bead core 8. The finishing roller 49 rotates along the upper surface 8d of the bead core 8. The finishing roller 49 is movable inward and outward in the radial direction of the bead core 8. An auxiliary roller 49a which is movable inward and outward in the radial direction of the bead core 8 is disposed at a position facing the finishing roller 49 with the bead core 8 interposed therebetween. The rotation axis of the auxiliary roller 49a is parallel to the rotation axes of the finishing roller 49 and the bead core 8. Thus, both ends of the rubber sheet S can be bonded under pressure to the upper surface 8d of the bead core 8 by the finishing roller 49. The finishing roller 49 is a drive roller driven by a motor (not illustrated), and the auxiliary roller 49a is a driven roller that rotates as the bead core 8 rotates. In addition, the finishing roller 49 and the auxiliary roller 49a may include a temperature adjustment mechanism that heats the rollers in order to increase the press-bonding force. Examples of the temperature adjustment mechanism include a temperature adjustment mechanism using hot water, a heater, a gas, or the like.

It is preferable that the peripheral speed of the outer peripheral surface of the drive roller (lower-side-surface press-bonding roller 43, first upper-side-surface press-bonding roller 45, first bending roller 46, second upper-side-surface press-bonding roller 47, second bending roller 48, finishing roller 49) is preferably higher than the peripheral speed of the outer surface of the bead core 8. Here, the outer peripheral surface of the drive roller indicates a surface that bonds the rubber sheet S under pressure to the bead core 8, and the outer surface of the bead core 8 indicates a surface facing the outer peripheral surface of the drive roller with the rubber sheet S interposed therebetween. When the peripheral speed of the outer peripheral surface of the drive roller is set higher than the peripheral speed of the outer surface of the bead core 8, the drive roller constantly feeds the rubber sheet S in the direction of winding the rubber sheet S, so that winding failure is reduced. In addition, tension is applied to the rubber sheet S, whereby the wound state is also improved.

If the peripheral speed of the outer peripheral surface of the drive roller is lower than the peripheral speed of the outer surface of the bead core 8, a winding failure such as a wrinkle or crease occurs in the rubber sheet S. In addition, when the peripheral speed of the outer peripheral surface of the drive roller and the peripheral speed of the outer surface of the bead core 8 are the same, there is no problem in the wound state of the rubber sheet S under ordinary circumstances. However, when the rotational speed of the bead core 8 is increased due to eccentricity, slippage, or the like of the bead core 8, wrinkles or meandering occur from that point, and this leads to winding failure.

As described above, the bead core 8 rotates as the rotary drum 3 rotates. Therefore, the rotational speed of the bead core 8 is determined by the rotational speed of the rotary drum 3. That is, the control unit 5 controls the rotational speed of the drive roller and the rotational speed of the rotary drum 3, specifically, the rotational speed of the motor that drives the drive roller and the rotational speed of the servomotor 30 that drives the rotary drum 3, such that the peripheral speed of the outer peripheral surface of the drive roller is higher than the peripheral speed of the outer surface of the bead core 8.

The peripheral speed of the outer peripheral surface of the drive roller is preferably 1.01 times or more the peripheral speed of the outer surface of the bead core 8. If the peripheral speed of the outer peripheral surface of the drive roller is less than 1.01 times the peripheral speed of the outer surface of the bead core 8, the effect of reducing winding failure cannot be obtained. In addition, the peripheral speed of the outer peripheral surface of the drive roller is preferably 1.3 times or less the peripheral speed of the outer surface of the bead core 8. When the peripheral speed of the outer peripheral surface of the drive roller is more than 1.3 times the peripheral speed of the outer surface of the bead core 8, the bead core 8 is pulled together with the rubber sheet S by the drive roller, which may affect the peripheral speed of the bead core 8. For example, the peripheral speed of the lower-side-surface press-bonding roller 43 is 1.01 to 1.10 times the peripheral speed of the bead core 8, the peripheral speed of the first upper-side-surface press-bonding roller 45 is 1.01 to 1.10 times the peripheral speed of the bead core 8, the peripheral speed of the first bending roller 46 is 1.1 to 1.2 times the peripheral speed of the bead core 8, the peripheral speed of the second upper-side-surface press-bonding roller 47 is 1.01 to 1.10 times the peripheral speed of the bead core 8, the peripheral speed of the second bending roller 48 is 1.1 to 1.2 times the peripheral speed of the bead core 8, and the peripheral speed of the finishing roller 49 is 1.1 to 1.2 times the peripheral speed of the bead core 8.

Further, it is preferable that the drive roller having a peripheral speed higher than the peripheral speed of the bead core 8 bends and bonds the rubber sheet 8 under pressure at the corner of the bead core 8 having a polygonal cross-sectional shape, and is disposed at a position where the bending angle of the rubber sheet 8 is 45° or more. Since a winding failure is likely to occur particularly at a position where the bending angle is large, it is effective to set the peripheral speed of the drive roller disposed at this position to be higher than the peripheral speed of the bead core 8 for reducing the winding failure.

In the present embodiment, it is particularly preferable that the cross-sectional shape of the bead core 8 is hexagonal, and the peripheral speeds of the outer peripheral surfaces of the first bending roller 46 and the second bending roller 48 disposed at the positions where the bending angle of the bead core 8 is 60° are higher than the peripheral speed of the outer surface of the bead core 8. In the present embodiment, the peripheral speeds of the outer peripheral surfaces of the first bending roller 46 and the second bending roller 48 are 1.15 times the peripheral speed of the outer surface of the bead core 8.

Next, the bead core covering method using the bead core covering apparatus 1 will be described. The bead core covering method according to the present embodiment includes: a step for affixing a part in the width direction of the rubber sheet S onto the outer surface of the rotating bead core 8 from the front end of the rubber sheet S; a step for winding the remaining part in the width direction of the rubber sheet S having been affixed to the outer surface of the bead core 8 along the cross-sectional shape of the bead core 8 sequentially from the part in the width direction toward an end in the width direction, wherein, in the step for winding the rubber sheet S along the cross-sectional shape of the bead core 8, the remaining part of the rubber sheet S in the width direction is bonded under pressure to the outer surface of the bead core 8 by the outer peripheral surface of the rotating drive roller, and the peripheral speed of the outer peripheral surface of the drive roller is higher than the peripheral speed of the outer surface of the bead core 8.

First, the bead core 8 is set in the covering device 4. At this time, the extruder 2 is disposed outside the covering device 4.

Next, the extruder 2 is moved forward to the rotary drum 3 so as to bring the die 21 close to the outer peripheral surface of the rotary drum 3.

Next, the extrusion of the rubber sheet S from the die 21 of the extruder 2 is started, and at the same time, the rotary drum 3 starts to rotate. Thus, the extruded rubber sheet S can be wound around the outer peripheral surface of the rotary drum 3 from the front end.

Next, the central part in the width direction of the rubber sheet S wound on the outer peripheral surface of the rotary drum 3 is affixed to the lower surface 8a of the rotating bead core 8 from the front end (see FIG. 4A).

Next, both ends in the width direction of the rubber sheet S affixed to the lower surface 8a of the bead core 8 are wound along the cross-sectional shape of the bead core 8 by the covering device 4 (see FIGS. 4B to 4I). Finally, the extruder 2 is retracted, and the bead core 8 covered with the rubber sheet S is removed from the covering device 4.

Further, it is preferable that, in the bead core covering method according to the present embodiment, the step for winding the rubber sheet S extruded by the extruder 2 through the die 21 around the outer peripheral surface of the rotary drum 3 from the front end includes: a preparation step for bringing the die 21 close to the rotary drum 3; a winding start step for forming a winding start part having a wedge-shaped cross section by starting rotation of the rotary drum 3 simultaneously with start of extrusion of the rubber from the die 21 which has been brought into close to the rotary drum 3, gradually increasing an extrusion amount of the rubber to a predetermined amount, and gradually increasing a distance from the rotary drum 3 to the die 21 to a predetermined distance corresponding to a desired thickness of the rubber sheet S; a winding step for winding the rubber sheet S by maintaining the extrusion amount of the rubber at the predetermined amount and maintaining the distance from the rotary drum 3 to the die 21 at the predetermined distance; and a winding end step for forming a winding end part having a wedge-shaped cross section by gradually decreasing the extrusion amount of the rubber from the predetermined amount, and gradually decreasing the distance from the rotary drum 3 to the die 21 from the predetermined distance.

When the rubber extruded by the extruder 2 is wound around the rotary drum 3, the extruded rubber passes through a gap between the die 21 and the outer peripheral surface of the rotary drum 3 while being rubbed by the die 21, and thus, the rubber having passed through the gap has a thickness of the gap.

That is, in the winding start step, the extrusion amount of the rubber is gradually increased to a predetermined amount, and the distance from the rotary drum 3 to the die 21 is gradually increased to a predetermined distance, whereby a winding start part with a wedge-shaped cross section which is constant in width and which is gradually increased in thickness to a desired thickness of the rubber sheet S can be formed. In the winding step, the extrusion amount of the rubber is maintained at the predetermined amount, and the distance from the rotary drum 3 to the die 21 is maintained at the predetermined distance, whereby the wound rubber has a desired thickness with a constant width. In addition, in the winding end step, the extrusion amount of the rubber is gradually decreased from the predetermined amount, and the distance from the rotary drum 3 to the die 21 is gradually decreased from the predetermined distance, whereby a winding end part with a wedge-shaped cross section which is constant in width and which is gradually decreased in thickness can be formed. The rubber sheet S is affixed to the outer surface of the bead core 8 such that the winding end part thus formed is overlapped with the winding start part. This can eliminate a difference in height at a joint portion between the winding start part and the winding end part. By using the method for forming the rubber sheet S described above in the production of a tire, a difference in height at the joint portion can be eliminated, so that air does not enter during vulcanization, and uniformity is improved. In the winding step, the distance from the rotary drum 3 to the die 21 may be set larger than the desired thickness of the rubber sheet S. When the shape of the discharge port of the die 21 is the same as the desired cross-sectional shape of the rubber sheet S, the rubber sheet S having a desired thickness can be formed by maintaining the extrusion amount of the rubber at a predetermined amount in the winding step.

### Other Embodiments

(1) The embodiment described above shows an example in which the central part in the width direction of the rubber sheet S wound on the outer peripheral surface of the rotary drum 3 is affixed to the inner peripheral surface (lower surface 8a) of the rotating bead core 8 from the front end of the rubber sheet S. However, the present invention is not limited thereto.

For example, the rotary drum 3 may be disposed on the outer peripheral side of the bead core 8, and the central part in the width direction of the rubber sheet S wound on the outer peripheral surface of the rotary drum 3 may be affixed to the outer peripheral surface (upper surface 8d) of the rotating bead core 8 from the front end of the rubber sheet S. This configuration can simplify the configuration of facility layout, and can easily respond to a size change of the bead core.

Further, the rotary drum 3 may be disposed on the side of the bead core 8, and the central part in the width direction of the rubber sheet S wound on the outer peripheral surface of the rotary drum 3 may be affixed to the side surface of the rotating bead core 8 from the front end of the rubber sheet S. This configuration can simplify the configuration of facility layout, and can easily respond to a size change of the bead core.

(2) The embodiment described above shows an example in which the position where the tip of the die 21 of the extruder 2 and the outer peripheral surface of the rotary drum 3 are closest to each other and the position where the outer surface of the bead core 8 and the outer peripheral surface of the rotary drum 3 are closest to each other are shifted by 180° in the rotation direction X of the rotary drum 3. However, the present invention is not limited thereto, and they may be shifted by 90° or 270°.

(3) In the above embodiment, the rubber sheet S extruded from the extruder 2 is directly affixed to the outer surface of the bead core 8 via the rotary drum 3, but the present invention is not limited thereto. The rubber sheet S may be formed to have a predetermined length in advance and such rubber sheet S may be affixed. Alternatively, the rubber sheet S wound around a bobbin may be affixed while being cut into a predetermined length.

### DESCRIPTION OF REFERENCE SIGNS

1 Bead core covering apparatus
2 Extruder
3 Rotary drum
4 Covering device
46 First bending roller
48 Second bending roller
5 Control unit
8 Bead core
S Rubber sheet

1. A bead core covering method for covering an annular bead core with a long, belt-like rubber sheet having a predetermined width, the method comprising:
a step for affixing, from a front end of the rubber sheet, a part in a width direction of the rubber sheet onto an outer surface of the bead core that is rotating; and
a step for winding a remaining part in the width direction of the rubber sheet having been affixed to the outer surface of the bead core along a cross-sectional shape of the bead core sequentially from the part in the width direction toward an end in the width direction,
wherein, in the step for winding the rubber sheet along the cross-sectional shape of the bead core, the remaining part in the width direction of the rubber sheet is bonded under pressure to the outer surface of the bead core by an outer peripheral surface of a drive roller that is rotating, and
a peripheral speed of the outer peripheral surface of the drive roller is higher than a peripheral speed of the outer surface of the bead core.

2. The bead core covering method according to claim 1, wherein the peripheral speed of the drive roller is 1.3 times or less the peripheral speed of the bead core.

3. The bead core covering method according to claim 1,
wherein the drive roller
bends and bonds the rubber sheet under pressure at a corner of the bead core having a polygonal cross section, and
is disposed at a position where a bending angle of the rubber sheet is 45° or more.

4. A bead core covering apparatus for covering an annular bead core with a long, belt-like rubber sheet having a predetermined width, the apparatus comprising:
a covering device that supports the bead core and rotates the bead core that is supported;
a drive roller for winding and bonding the rubber sheet under pressure on an outer surface of the bead core, the drive roller being provided to the covering device; and
a control unit that controls the covering device and the drive roller,
wherein the control unit is configured to affix, from a front end of the rubber sheet, a part in a width direction of the rubber sheet onto the outer surface of the bead core that is rotating, and to bond under pressure a remaining part in the width direction of the rubber sheet having been affixed to the outer surface of the bead core along a cross-sectional shape of the bead core sequentially from the part in the width direction toward an end in the width direction by an outer peripheral surface of the drive roller that is rotating, and
a peripheral speed of the outer peripheral surface of the drive roller is higher than a peripheral speed of the outer surface of the bead core.

5. The bead core covering apparatus according to claim 4, wherein the peripheral speed of the drive roller is 1.3 times or less the peripheral speed of the bead core.

6. The bead core covering apparatus according to claim 4,
wherein the drive roller
bends and bonds the rubber sheet under pressure at a corner of the bead core having a polygonal cross section, and
is disposed at a position where a bending angle of the rubber sheet is 45° or more.
